(19) United States
(12) Patent Application Publication
(10) Pub. No.: US 2008/0221862 A1
(43) Pub. Date: Sep. 11, 2008

(54) MOBILE LANGUAGE INTERPRETER WITH LOCALIZATION

(75) Inventors: Hui Guo, Santa Clara, CA (US); Zhaowei Charlie Jiang, Palo Alto, CA (US)

Correspondence Address: Yahoo! Inc.;c/o DARBY & DARBY P.C., P.O. BOX 770, Church Street Station, NEW YORK, NY, 10008-0770, US

(73) Assignee: Yahoo! Inc., Sunnyvale, CA (US)

(21) Appl. No.: 11/684,470

(22) Filed: Mar. 9, 2007

(51) Int. Cl. G06F 17/28

(52) U.S. Cl. 704/2

(57) ABSTRACT

A mobile device, system, and method are directed towards enabling a mobile user to request and obtain audio, graphical, and/or textual language translations between one or more different languages virtually in real-time. In one embodiment, a system is configured to enable a mobile user to select a first language from a plurality of languages. A second language may be determined based on a current location of the mobile device, selected by the user from the plurality of languages. The user may then provide an input in one language, which may be transmitted to a server device, where a determination is made which of the languages the input is, and provides a translation to the other language back to the mobile device. In one embodiment, the server device may also provide related information to the translated input, including pronunciation support, video and/or audio clips, word origin, synonyms, or the like.

### TECHNICAL FIELD

The present invention relates generally to language translators and, more particularly, but not exclusively to enabling dynamic, real-time, human friendly and personalized language translation services with multimedia capabilities including text, graphics, voice and/or video through a mobile device communicating with remote servers, based in part, on a current location of the mobile device.

### BACKGROUND

More and more businesses have become international, often having divisions, in several foreign countries across the globe at the same time. As a result, there is a growing need for employees, at virtually every level of the business, to be able to communicate with others from a foreign country. Unfortunately, many of the employees within these divisions may speak only their native language. However, the benefits of being able to communicate with other employees in their native language are bountiful. For example, learning to speak another language enables the employees to “step inside the mind and context of that other culture,” which in turn allows the employees to reduce mistrust and/or misunderstandings, and to improve cooperation. Learning to speak another language also enables the business to grow in the other countries, to make more sales and to negotiate and secure contracts.

Learning another language takes time and effort. Unfortunately, many employees find little or no time to learn another language. In addition, because businesses may span multiple countries, with a variety of different languages being spoken, it may be difficult, if not almost impossible to learn each language.

In addition, more and more people are traveling to other countries to discover and see the world. Learning to speak the other language enables the traveler to better appreciate the other cultures, to order food and drink, to read signs, and to ask for help. Unfortunately, many of these travelers may also be unable to find the time to learn another language, let alone, several different languages.

Moreover, more and more people are immigrating to the United States from other countries with only a limited ability to speak English. Therefore, there is an increased need for nurses, doctors, police officers, and government officers to be able to communicate with these new citizens. Unfortunately, this may require these professionals to learn multiple languages. However, this is unlikely to happen due to their busy lives. Therefore, it is with respect to these considerations and others that the present invention has been made.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

FIG. 1 is a system diagram of one embodiment of an environment in which the invention may be practiced;

FIG. 2 shows one embodiment of a mobile device that may be included in a system implementing the invention;

FIG. 3 shows one embodiment of a network device that may be included in a system implementing the invention;

FIG. 4 illustrates a logical flow diagram generally showing one embodiment of a process for performing a dynamic audio language translation based, in part, on a current physical location;

FIG. 5 generally showing one embodiment of a process for performing a dynamic graphical language translations based, in part, on a current physical location; and

FIG. 6 illustrates a logical flow diagram generally showing one embodiment of a process for performing dynamic language education based, in part, on a current physical location, in accordance with the present invention.

### DETAILED DESCRIPTION

The present invention now will be described more fully hereinafter with reference to the accompanying drawings, which form a part hereof, and which show, by way of illustration, specific embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

Briefly stated the present invention is directed towards a configuration that enables a mobile user to request and obtain audio language translations between one or more different languages virtually in real-time, as well as translations of graphical inputs. In one embodiment, a system is configured to enable a mobile user to select a first language from a plurality of languages. A second language may be determined based on a current location of the mobile device, or selected by the user from the plurality of languages. The user may then provide an audio input in the first or second language, which may be transmitted to a server device, where a determination is made which of the languages the audio input is in, and provides a translation to the other language. In addition, the mobile user may provide a graphic input, such as a picture, where text may be extracted using such as a language specific OCR mechanism. The server may then provide a translation of the extracted text into one of the first or second language. Similarly, the user may provide text which may also be sent to the server to be translated. In one embodiment, the server may also provide related information to the translated audio, graphical, and/or textual input, including, but not limited to pronunciation support, video and/or audio clips, word origin, synonyms, or the like. Moreover, in one embodiment, a person may compose and send an SMS message, or the like, in the first language and the server device may be configured to intercept the message, translate it to the second language, and forward the translated message to the mobile device. Similarly, the mobile device user may respond in the second language, and the server device may translate the response into the first language before forwarding it to the person. In one embodiment, the mobile device may be configured to operate to perform at least some of the language selection, OCR text extraction, and/or translation.

### Illustrative Operating Environment

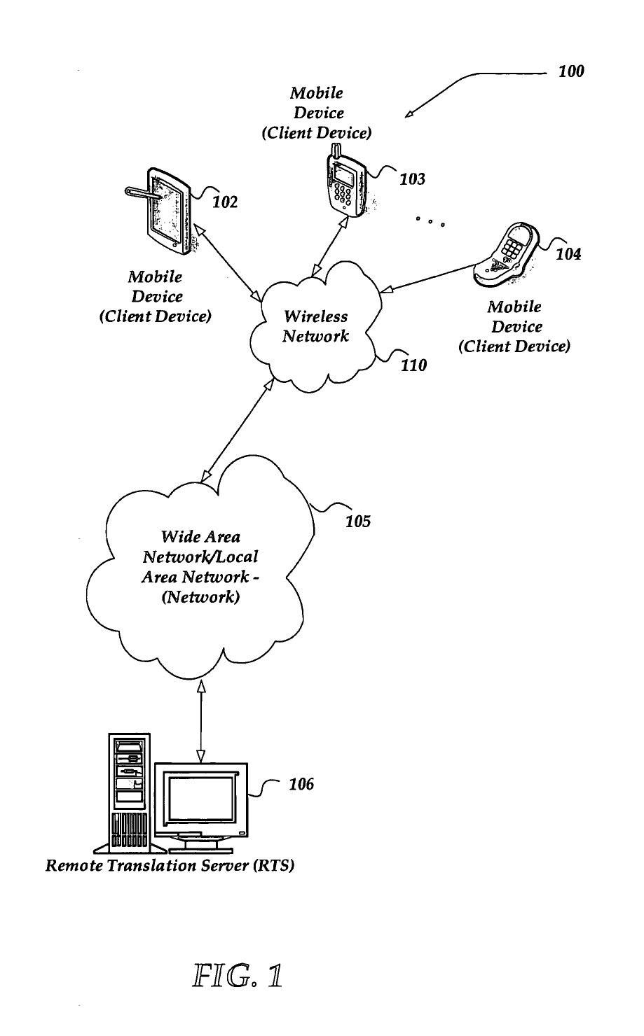

FIG. 1 shows components of one embodiment of an environment in which the invention may be practiced. Not all the components may be required to practice the invention, and variations in the arrangement and type of the components may be made without departing from the spirit or scope of the invention. As shown, system 100 of FIG. 1 includes local area networks (“LANs”)/wide area networks (“WANs”)—(network) 105, wireless network 110, Remote Translation Server (RTS) 106, and mobile devices (client devices) 102-104.

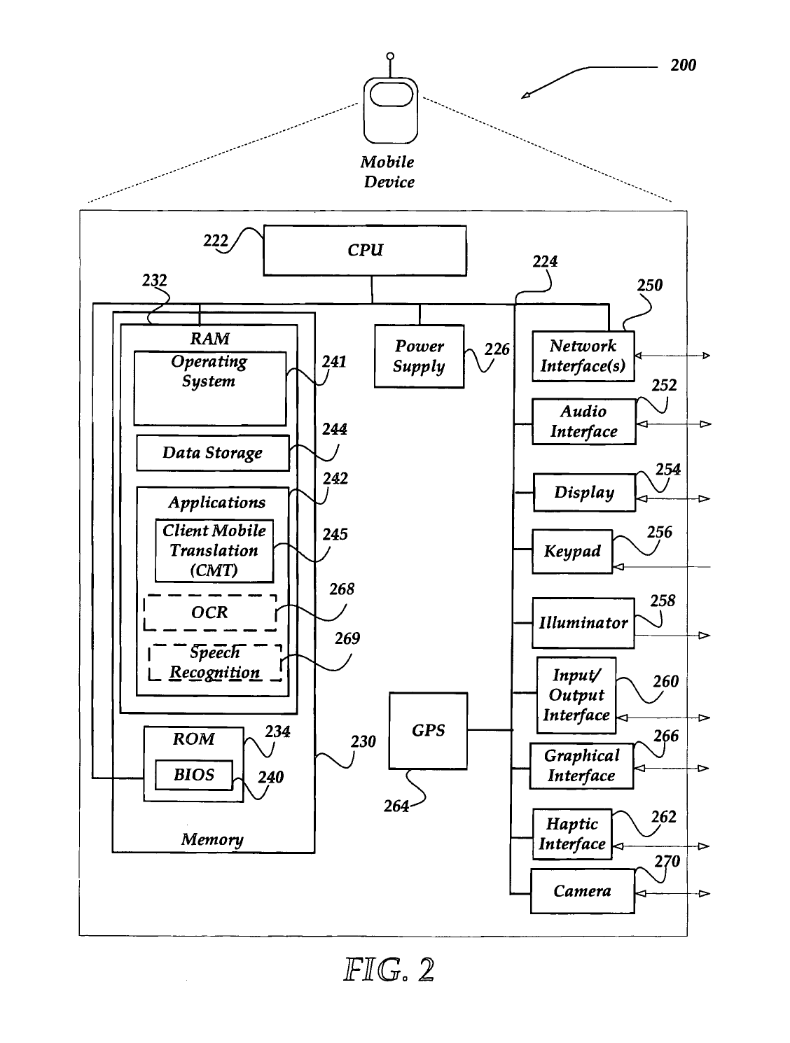

One embodiment of mobile devices 102-104 is described in more detail below in conjunction with FIG. 2. Generally, however, mobile devices 102-104 may include virtually any portable computing device capable of receiving and sending a message over a network, such as network 105, wireless network 110, or the like. Mobile devices 102-104 may also be described generally as client devices that are configured to be portable. Thus, mobile devices 102-104 may include virtually any portable computing device capable of connecting to another computing device and receiving information. Such devices include portable devices such as, cellular telephones, smart phones, display pagers, radio frequency (RF) devices, infrared (IR) devices, Personal Digital Assistants (PDAs), handheld computers, laptop computers, wearable computers, tablet computers, integrated devices combining one or more of the preceding devices, and the like. As such, mobile devices 102-104 typically range widely in terms of capabilities and features. For example, a cell phone may have a numeric keypad and a few lines of monochrome LCD display on which only text may be displayed. In another example, a web-enabled mobile device may have a touch sensitive screen, a stylus, and several lines of color LCD display in which text, graphics, and video may be displayed.

A web-enabled mobile device may include a browser application that is configured to receive and to send web pages, web-based messages, and the like. The browser application may be configured to receive and display graphics, text, multimedia, and the like, employing virtually any web based language, including a wireless application protocol messages (WAP), and the like. In one embodiment, the browser application is enabled to employ Handheld Device Markup Language (HDML), Wireless Markup Language (WML), WMLScript, JavaScript, Standard Generalized Markup Language (SMGL), HyperText Markup Language (HTML), eXtensible Markup Language (XML), and the like, to display and send a message.

Mobile devices 102-104 also may include at least one client application that is configured to receive content from another computing device. The client application may include a capability to provide and receive textual content, graphical content, audio content, and the like. The client application may further provide information that identifies itself, including a type, capability, name, and the like. In one embodiment, mobile devices 102-104 may uniquely identify themselves through any of a variety of mechanisms, including a phone number, Mobile Identification Number (MIN), an electronic serial number (ESN), or other mobile device identifier. The information may also indicate a content format that the mobile device is enabled to employ. Such information may be provided in a message, or the like, sent to RTS 106, or other computing devices. The information may also indicate a display capability of the mobile device, a current physical location, as well as other information about mobile devices 102-104.

Mobile devices 102-104 may also be configured to communicate a message, such as through Short Message Service (SMS), Multimedia Message Service (MMS), IP Multimedia Subsystem (IMS), instant messaging (IM), internet relay chat (IRC), Mardam-Bey's IRC (mIRC), Voice Over IP (VOIP), Jabber, and the like, between another computing device, such as RTS 106, another mobile device, or the like. However, the present invention is not limited to these messaging protocols, and virtually any other messaging protocol may be employed. In addition, mobile devices 102-104 may be configured to enable at least some of the communications to be encrypted using virtually any of a variety of encryption mechanisms, including, but not limited to SSL/TLS, Wireless Equivalent Privacy (WEP), Wi-Fi Protected Access (WPA), or the like.

As described further below, mobile devices 102-104 may be configured to operate like a portable linguist, or translator of a plurality of different languages for a user. That is, mobile devices 102-104 may operate as an interpreter for audio conversations between the user and one or more other persons, a translator for comprehension of a graphic input, such as a picture, or the like, as well as an educator, providing explanations, and/or context to text, symbols, or the like, in another language. In one embodiment, the mobile device user may select to send to another person, of a different computing device, a message in one language. The message may be an SMS message, IM message, or the like. RTS 106 may be configured to intercept the message, translate it to another language, and then forward the translated message to the other person. In one embodiment, at least one of the languages may be determined based on a current location of the mobile device, or of the other computing device.

Thus, in one embodiment, mobile devices 102-104 may include speech recognition applications, Optical Character Recognition (OCR) applications, or the like. In one embodiment, the speech recognition, and/or OCR application may be configured to be specific to a particular language. For example, the speech recognition and/or OCR application may include a component that attempts to determine a language associated with an input. In another embodiment, mobile devices 102-104 may be configured to receive an input, either as an audio input, a graphical input, and/or a textual or symbolic input, which may then be provided to RTS 106 for translation. Thus, in one embodiment, the speech recognition and/or OCR application may reside on RTS 106 instead.

Wireless network 110 is configured to couple mobile devices 102-104 and its components with network 105. Wireless network 110 may include any of a variety of wireless sub-networks that may further overlay stand-alone ad-hoc networks, and the like, to provide an infrastructure-oriented connection for mobile devices 102-104. Such sub-networks may include mesh networks, Wireless LAN (WLAN) networks, cellular networks, and the like.

Wireless network 110 may further include an autonomous system of terminals, gateways, routers, and the like connected by wireless radio links, and the like. These connectors may be configured to move freely and randomly and organize themselves arbitrarily, such that the topology of wireless network 110 may change rapidly.

Wireless network 110 may further employ a plurality of access technologies including 2nd (2G), 3rd (3G) generation radio access for cellular systems, WLAN, Wireless Router (WR) mesh, and the like. Access technologies such as 2G, 3G, and future access networks may enable wide area coverage for mobile devices, such as mobile devices 102-104 with various degrees of mobility. For example, wireless network 110 may enable a radio connection through a radio network access such as Global System for Mobil communication (GSM), General Packet Radio Services (GPRS), Enhanced Data GSM Environment (EDGE), WEDGE, Bluetooth, High Speed Downlink Packet Access (HSDPA), Universal Mobile Telecommunications System (UMTS), Wi-Fi, Zigbee, Wideband Code Division Multiple Access (WCDMA), and the like. In essence, wireless network 110 may include virtually any wireless communication mechanism by which information may travel between mobile devices 102-104 and another computing device, network, and the like.

Network 105 is configured to couple RTS 106 and its components with other computing devices, including, mobile devices 102-104, and through wireless network 110 to mobile devices 102-104. Network 105 is enabled to employ any form of computer readable media for communicating information from one electronic device to another. Also, network 105 can include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. In essence, network 105 includes any communication method by which information may travel between RTS 106, and other computing devices.

Additionally, communication media typically embodies computer-readable instructions, data structures, program modules, or other data in a modulated data signal such as a carrier wave, data signal, or other transport mechanism and includes any information delivery media. The terms “modulated data signal,” and “carrier-wave signal” includes a signal that has one or more of its characteristics set or changed in such a manner as to encode information, instructions, data, and the like, in the signal. By way of example, communication media includes wired media such as twisted pair, coaxial cable, fiber optics, wave guides, and other wired media and wireless media such as acoustic, RF, infrared, and other wireless media.

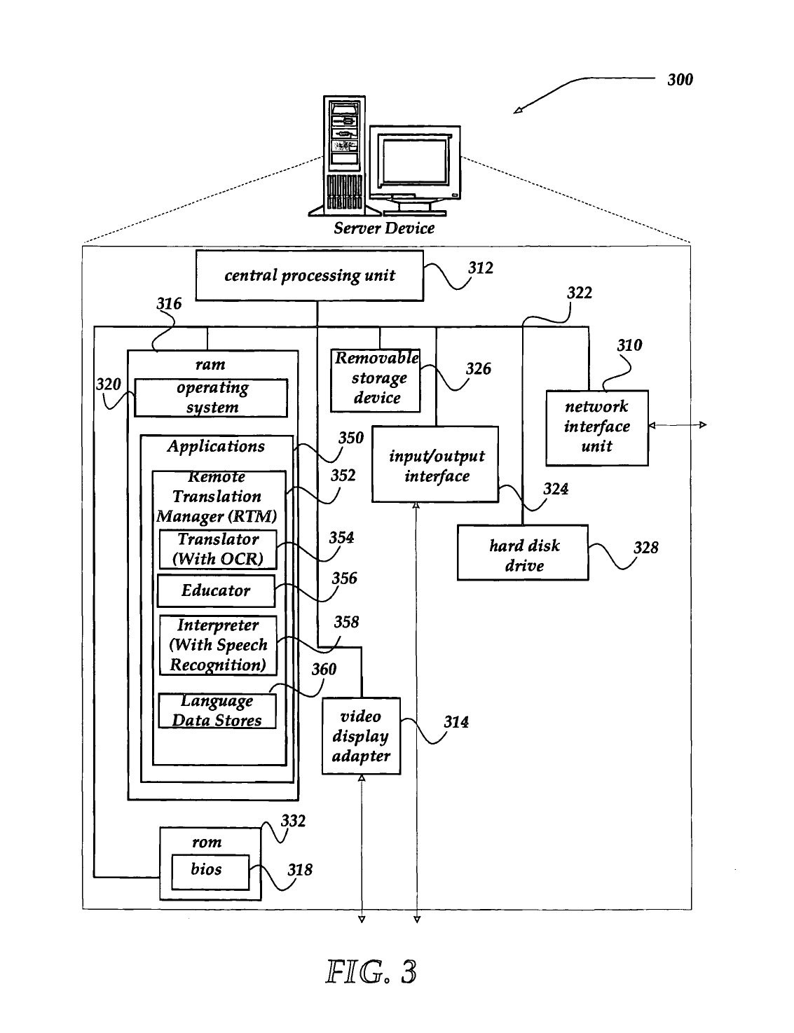

One embodiment of RTS 106 is described in more detail below in conjunction with FIG. 3. Briefly, however, RTS 106 may include any computing device capable of connecting to network 105 to enable a user of mobile devices 102-104 to request and receive translations of an audio, graphical, and/or textual or symbolic input into another language. In one embodiment, at least one of the languages is selected based, in part, on a current location of the mobile device, or another computing device.

In one embodiment, RTS 106 may receive the input encrypted, decrypt the input, and determine the language of the input based on speech recognition, OCR language pattern recognition, and/or heuristics, a current location of the input source device, of the destination device, or from a user input. In another embodiment, the input may be received un-encrypted. In one embodiment, the translated response may be provided encrypted.

RTS 106 may also provide related information to the input, including, but not limited to a pronunciation of the input, etymology of the input, an image and/or video clip illustrating, for example, a meaning of the input, how to use the input, a graphical representation of the input, or the like.

Devices that may operate as RTS 106 include personal computers desktop computers, multiprocessor systems, microprocessor-based or programmable consumer electronics, network PCs, servers, and the like.

Although FIG. 1 illustrates RTS 106 as a single computing device, the invention is not so limited. For example, one or more functions of RTS 106 may be distributed across one or more distinct computing devices, without departing from the scope or spirit of the present invention.

### Illustrative Mobile Client Environment

FIG. 2 shows one embodiment of mobile device 200 that may be included in a system implementing the invention. Mobile device 200 may include many more or less components than those shown in FIG. 2. However, the components shown are sufficient to disclose an illustrative embodiment for practicing the present invention. Mobile device 200 may represent, for example, mobile devices 102-104 of FIG. 1.

As shown in the figure, mobile device 200 includes a processing unit (CPU) 222 in communication with a mass memory 230 via a bus 224. Mobile device 200 also includes a power supply 226, one or more network interfaces 250, an audio interface 252 that may be configured to receive an audio input as well as to provide an audio output, a display 254, a keypad 256, an illuminator 258, an input/output interface 260, a haptic interface 262, and a global positioning systems (GPS) receiver 264. Power supply 226 provides power to mobile device 200. A rechargeable or non-rechargeable battery may be used to provide power. The power may also be provided by an external power source, such as an AC adapter or a powered docking cradle that supplements and/or recharges a battery. Mobile device 200 may also include a graphical interface 266 that may be configured to receive a graphical input, such as through a camera, scanner, or the like. In addition, mobile device 200 may also include its own camera 272, for use in capturing graphical images. In one embodiment, such captured images may be evaluated using OCR 268, or the like.

Mobile device 200 may optionally communicate with a base station (not shown), or directly with another computing device. Network interface 250 includes circuitry for coupling mobile device 200 to one or more networks, and is constructed for use with one or more communication protocols and technologies including, but not limited to, global system for mobile communication (GSM), code division multiple access (CDMA), time division multiple access (TDMA), user datagram protocol (UDP), transmission control protocol/Internet protocol (TCP/IP), SMS, general packet radio service (GPRS), WAP, ultra wide band (UWB), IEEE 802.16 Worldwide Interoperability for Microwave Access (WiMax), SIP/RTP, Bluetooth, Wi-Fi, Zigbee, UMTS, HSDPA, WCDMA, WEDGE, or any of a variety of other wireless communication protocols. Network interface 250 is sometimes known as a transceiver, transceiving device, or network interface card (NIC).

Audio interface 252 is arranged to produce and receive audio signals such as the sound of a human voice. For example, audio interface 252 may be coupled to a speaker and microphone (not shown) to enable telecommunication with others and/or generate an audio acknowledgement for some action. Display 254 may be a liquid crystal display (LCD), gas plasma, light emitting diode (LED), or any other type of display used with a computing device. Display 254 may also include a touch sensitive screen arranged to receive input from an object such as a stylus or a digit from a human hand.

Keypad 256 may comprise any input device arranged to receive input from a user. For example, keypad 256 may include a push button numeric dial, or a keyboard. Keypad 256 may also include command buttons that are associated with selecting and sending images. Illuminator 258 may provide a status indication and/or provide light. Illuminator 258 may remain active for specific periods of time or in response to events. For example, when illuminator 258 is active, it may backlight the buttons on keypad 256 and stay on while the client device is powered. Also, illuminator 258 may backlight these buttons in various patterns when particular actions are performed, such as dialing another client device. Illuminator 258 may also cause light sources positioned within a transparent or translucent case of the client device to illuminate in response to actions.

Mobile device 200 also comprises input/output interface 260 for communicating with external devices, such as a headset, or other input or output devices not shown in FIG. 2. Input/output interface 260 can utilize one or more communication technologies, such as USB, infrared, Bluetooth™, or the like. Haptic interface 262 is arranged to provide tactile feedback to a user of the client device. For example, the haptic interface may be employed to vibrate mobile device 200 in a particular way when another user of a computing device is calling.

GPS transceiver 264 can determine the physical coordinates of mobile device 200 on the surface of the Earth, which typically outputs a location as latitude and longitude values. GPS transceiver 264 can also employ other geo-positioning mechanisms, including, but not limited to, triangulation, assisted GPS (AGPS), E-OTD, CI, SAI, ETA, BSS or the like, to further determine the physical location of mobile device 200 on the surface of the Earth. It is understood that under different conditions, GPS transceiver 264 can determine a physical location within millimeters for mobile device 200; and in other cases, the determined physical location may be less precise, such as within a meter or significantly greater distances. In one embodiment, however, mobile device may through other components, provide other information that may be employed to determine a physical location of the device, including for example, a MAC address, IP address, or the like.

Mass memory 230 includes a RAM 232, a ROM 234, and other storage means. Mass memory 230 illustrates another example of computer storage media for storage of information such as computer readable instructions, data structures, program modules or other data. Mass memory 230 stores a basic input/output system (“BIOS”) 240 for controlling low-level operation of mobile device 200. The mass memory also stores an operating system 241 for controlling the operation of mobile device 200. It will be appreciated that this component may include a general purpose operating system such as a version of UNIX, or LINUX™, or a specialized client communication operating system such as Windows Mobile™, or the Symbian® operating system. The operating system may include, or interface with a Java virtual machine module that enables control of hardware components and/or operating system operations via Java application programs.

Memory 230 further includes one or more data storage 244, which can be utilized by mobile device 200 to store, among other things, applications 242 and/or other data. For example, data storage 244 may also be employed to store information that describes various capabilities of mobile device 200. The information may then be provided to another device based on any of a variety of events, including being sent as part of a header during a communication, sent upon request, or the like.

In one embodiment, data storage 244 may also include language data obtained during translations of an input, as well as the input, and/or related information. In this manner, mobile device 200 may maintain, at least for some period of time, recently translated input, thus potentially speeding up translations. Based on some event, elapsed time, user input, or the like, such language data may be purged to minimize data storage 244 overruns. In one embodiment, at least some of a first language or a second language dictionary, or the like may also be stored in data storage 244. At least a portion of the capability information, and/or language data may also be stored on a disk drive or other storage medium (not shown) within mobile device 200.

Applications 242 may include computer executable instructions which, when executed by mobile device 200, transmit, receive, and/or otherwise process messages (e.g., SMS, MMS, IMS. IM, email, and/or other messages), audio, video, and enable telecommunication with another user of another client device. Other examples of application programs include calendars, browsers, email clients, IM applications, VOIP applications, contact managers, task managers, transcoders, database programs, word processing programs, security applications, spreadsheet programs, games, search programs, and so forth. Applications 242 may further include client mobile translation (CMT) 245, optional OCR application 268, and optional speech recognition application 269.

In one embodiment, optional speech recognition application 269 and/or optional OCR application 268 may be configured to determine an input language. In one embodiment, optional speech recognition application 269 and/or optional OCR application 268 may be provided information indicating in which language is the input.

CMT 245 is configured to enable a user to obtain language translation, interpretation, and/or education services. CMT 245 may be an application, downloadable J2ME application, web-based interface, script, applet, or the like. In one embodiment, CMT 245 is configured to interact with OCR 268, speech recognition application 269, and/or a remote server device to provide the language translation, interpretation, and/or education services.

CMT 245 may be configured to receive a selection of a first language, and, enable a determination of a second language. In one embodiment the determination of the second language may be based on a current location of mobile device 200, a user selection, or the like. In one embodiment, CMT 245 may provide a list of a plurality of languages from which the first and second languages may be selected. Such plurality of languages may be made available from the remote server device, thereby providing a highly dynamic and flexible translation environment.

CMT 245 may be further configured to receive an input either as an audio input, graphical input, and/or a textual input. CMT 245 may then store the input in data storage 244. CMT 245 may employ OCR 268, and/or speech recognition application 269, to extract text, and/or determine a language associated with the input. In one embodiment, CMT 245 may provide the input over a network to the remote server device. In one embodiment, CMT 245 may have the input encrypted prior to providing it to the remote server device. CMT 245 may also employ MMS, IMS, or the like, to send and/or receive the input to and/or receive the response from the remote server device.

CMT 245 may receive from the remote server device, a translation of the input into the first or second language selected as being different from than that language in which the input is originally in. In addition, CMT 245 may receive information related to the input, including, but not limited, to a graphical representation of the input or translated input, a definition of the input or translated input, pronunciation file, synonyms, an image or video clip illustrating how to use the translated input, an origin, history, meaning, or the like related to the input or the translated input. In one embodiment, CMT 245 may receive the translated input and/or related information as encrypted. CMT 245 may then employ a decryption application to decrypt the received data.

CMT 245 may also be configured to enable the user of mobile device 200 to communicate translated messages using any of a variety of messaging applications, including, but not limited to SMS, IM, email, or the like. Thus, in one embodiment, CMT 245 may receive a message in one language, and translate the message to another language, based in part on the selected and/or determined first and second languages.

CMT 245 may be configured to manage at least a portion of data storage 244 being associated with language data. For example, CMT 245 may provide for storage, and/or based on some event, purge language data from data storage 244.

### Illustrative Server Environment

FIG. 3 shows one embodiment of a network device, according to one embodiment of the invention. Server device 300 may include many more components than those shown. The components shown, however, are sufficient to disclose an illustrative embodiment for practicing the invention. Server device 300 may represent, for example, RTS 106 of FIG. 1.

Server device 300 includes processing unit 312, video display adapter 314, and a mass memory, all in communication with each other via bus 322. The mass memory generally includes RAM 316, ROM 332, and one or more permanent mass storage devices, such as hard disk drive 328, and removable storage device 326 that may represent a tape drive, optical drive, and/or floppy disk drive. The mass memory stores operating system 320 for controlling the operation of server device 300. Any general-purpose operating system may be employed. Basic input/output system (“BIOS”) 318 is also provided for controlling the low-level operation of server device 300. As illustrated in FIG. 3, server device 300 also can communicate with the Internet, or some other communications network, via network interface unit 310, which is constructed for use with various communication protocols including the TCP/IP protocol, Wi-Fi, Zigbee, WCDMA, HSDPA, Bluetooth, WEDGE, EDGE, UMTS, or the like. Network interface unit 310 is sometimes known as a transceiver, transceiving device, or network interface card (NIC).

The mass memory as described above illustrates another type of computer-readable media, namely computer storage media. Computer storage media may include volatile, nonvolatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

The mass memory also stores program code and data. One or more applications 350 are loaded into mass memory and run on operating system 320. Examples of application programs may include transcoders, schedulers, calendars, database programs, word processing programs, HTTP programs, customizable user interface programs, IPSec applications, encryption programs, security programs, VPN programs, SMS message servers, IM message servers, email servers, account management and so forth. Applications 350 may also include Remote Translation Manager (RTM) 352. RTM 352 may further include various components, including, but not limited to Translator (with OCR) 354, Educator 356, Interpreter (with speech recognition) 358, and language data stores 360.

Language data stores 360 includes a plurality of language stores and may include one or more databases, language search tools, dictionaries, video clips, audio clips, images, or the like for each of the plurality of languages. By making a plurality of languages available to the mobile device for virtually real-time language translation/interpretation/education services, server device 300 provides a dynamic, flexible, real-time, human friendly and personalized capability to the mobile device user. Thus, the mobile device user is not necessarily dependent upon downloading or otherwise providing onto their mobile device multiple language stores. This may come in handy, for example, when several languages are being used during a single audio conversation, and the mobile device user wants to have each of the audio inputs dynamically translated.

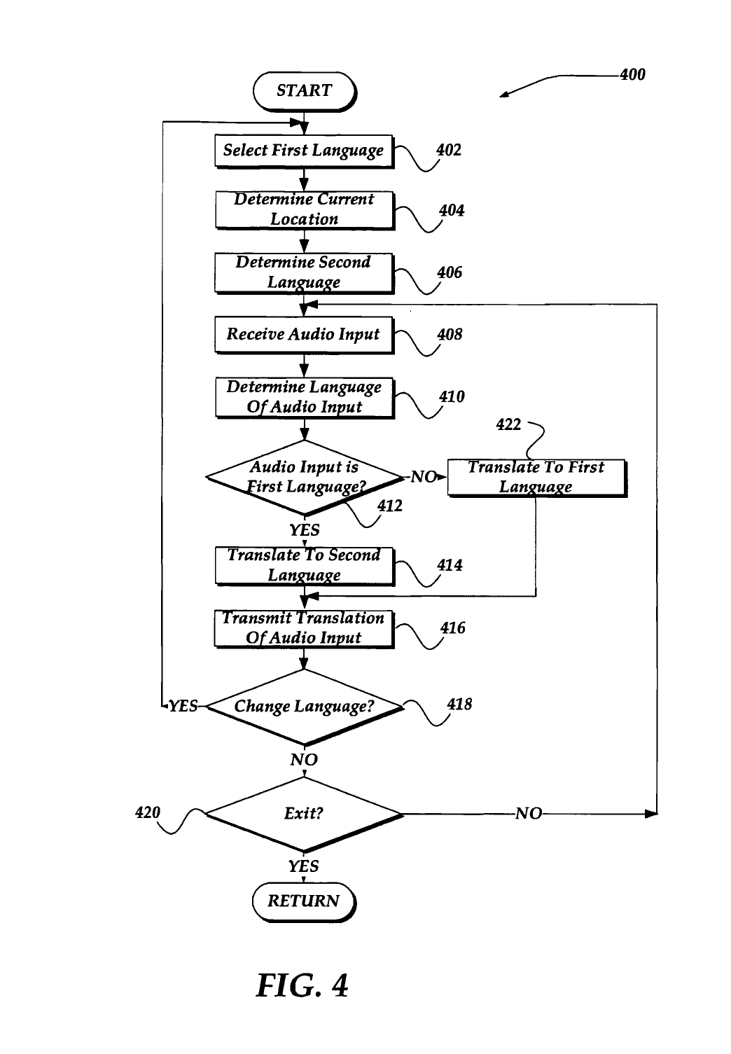

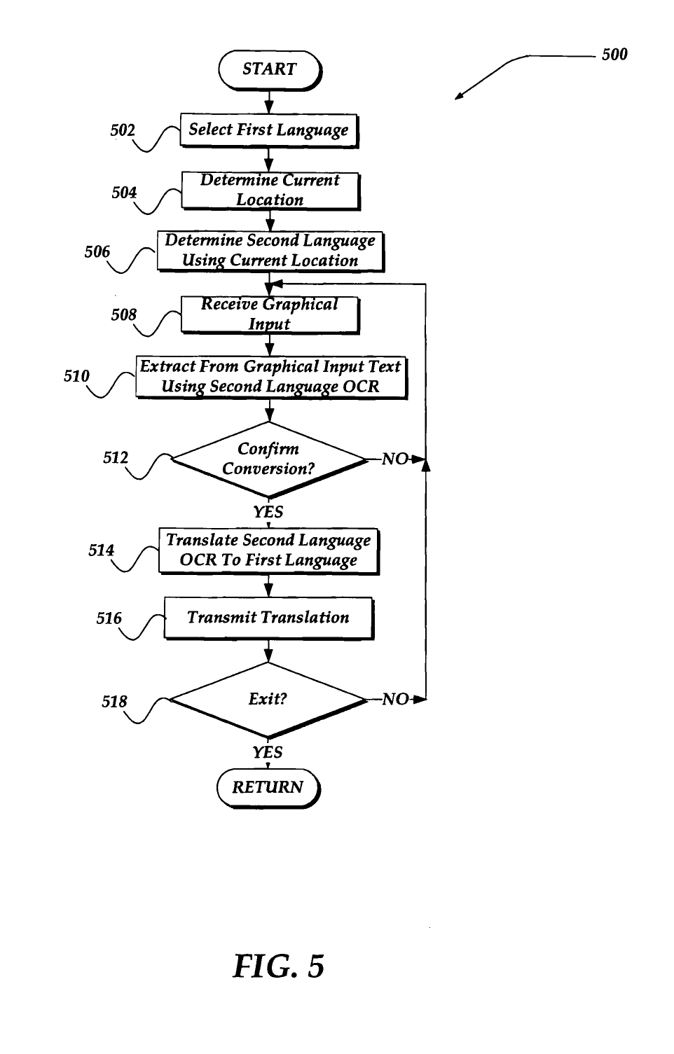

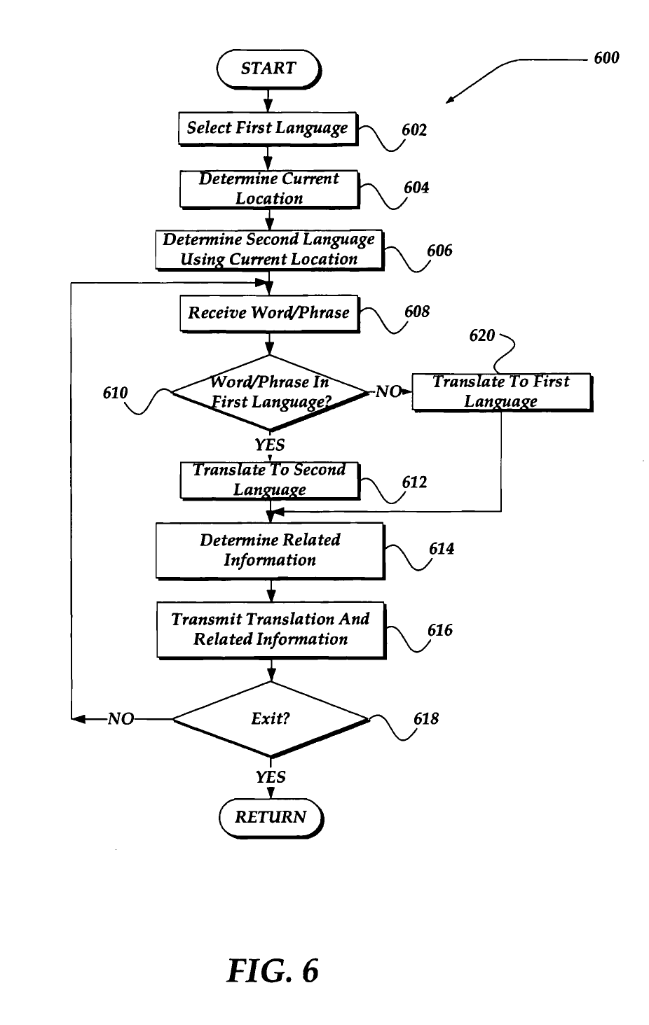

RTM 354 may represent a master interface that enables selection and execution of one or more of the subsystems (e.g., Translator (with OCR) 354, Educator 356, and Interpreter (with speech recognition) 358). For example, where the mobile user provides an audio input, RTM 354 may select to employ interpreter 358. Where the input is graphical, RTM 354 may select to employ translator 354, and similarly, where the mobile device user provides textual input for education, RTM 354 may select to employ educator 356. In one embodiment, Interpreter 358 may employ, at least in part, process 400 of FIG. 4 to perform at least some of its actions; translator 354 may employ, at least in part, process 500 of FIG. 5 to perform at least some of its actions; and educator 356 may employ at least in part, process 600 of FIG. 6 to perform at least some of its actions; each of which are described in more detail below.

It should be recognized, that RTM 354 may also be configured and arranged to enable translation of an input to also be performed, at least in part, using a live human translation service. Thus, in at least one embodiment, where a component of the invention is deemed inadequate, or otherwise, unavailable, insufficient, or the like, a human may be requested to perform at least in part a translation from one language to another language.

In addition RTM 354 may also be configured to enable a user of a mobile device to communicate translated messages using any of a variety of messaging applications, including, but not limited to SMS, IM, email, or the like. Thus, in one embodiment, RTM 354 may receive a message in one language, and translate the message to another language, based in part on the selected and/or determined first and second languages.

As noted above in conjunction with FIGS. 2-3, at least some actions may be performed within the mobile device, or communicated to a remote server device and be performed by the remote server device. The decision of where the actions may be performed may be based on a variety of factors, including, without limit to, a capacity of the mobile device, a capacity of the network used to communicate between the mobile device and remote server device, or the like. Thus, which device performs a given action may change with advances in network technology, mobile device capacity, or the like.

### Generalized Operation

The operation of certain aspects of the invention will now be described with respect to FIGS. 4-6. FIG. 4 illustrates a logical flow diagram generally showing one embodiment of a process for performing a dynamic audio language translation based, in part, on a current physical location of a mobile device. As described above, process 400 of FIG. 4 may be implemented entirely within a mobile device, such as mobile devices 102-104 of FIG. 1, where the mobile device may be considered as a thick client device. Alternatively, in another embodiment, process 400 may be performed within a server device, such as RTS 106 of FIG. 1, where, for example, a mobile device provides selected inputs, and receives selected output. In such an embodiment, the mobile device may operate as a thin client device. However, the invention is no so constrained, and portions of process 400 may be performed within the mobile device, while other portions may be performed with a server device, without departing from the scope of the invention.

In any event, process 400 may begin, after a start block, at block 402, where a user of the mobile device has selected to perform a language translation using audio input. At block 402, the user may select a first language. The first language is typically the language with which the user is most comfortable. However, the user may select any of a variety of other languages as the first language. In one embodiment, the selection of the first language may be performed using a menu, a text field, a scroll screen, or the like, to input a name of the first language. However, the user may also, in one embodiment, commence speaking the first language, and allow the invention to seek to recognize the first language. When the invention determines what the first language might be, its name may be displayed to the user for confirmation. In still another embodiment, the first language may be selected based on a default first language that may be determined based on where the user is registered (e.g., what country), what language the mobile device employs to display other menus, applications, or the like, or based on a variety of other selection criteria.

In any event, process 400 moves next to block 404, where a current physical location of the mobile device is determined. In one embodiment, where the mobile device includes a GPS transceiver, or similar locator mechanism, the current physical location may be obtained from the mobile device. However, in another embodiment, the user of the mobile device may also input the current physical location, using any of physical coordinates, city name, country name, or the like.

Processing continues next to block 406, where, in one embodiment, the second language is determined based on the current physical location of the mobile device. Thus, for example, if the current physical location of the mobile device is in Beijing, the second language may be determined to be Mandarin (or Putonghua) Chinese, whereas if the current physical location of the mobile device is in Paris, France, the second language might be determined to be Parisian French. However, the invention is not so constrained to using a current physical location of the mobile device to determine the second language. For example, in one embodiment, the user may select the second language, another user may speak, and the invention may attempt to determine the second language, or the like.

Process 400 then continues to block 408, where an audio input is received. The audio input may be the user speaking, or another user speaking into an audio input interface to the mobile device. Processing flows next to block 410, where a determination is made in which of the first or the second language is the audio input. In one embodiment, the determination may be made using speech recognition and/or language pattern recognition. In one embodiment, the name of the determined language may be displayed to the user, for confirmation that the audio input is properly determined as its language.

Processing continues to decision block 412, where a determination is made whether the audio input is in the first language. If so, processing continues to block 414 where the audio input is translated into the second language. In one embodiment, the speech recognition may be performed at the mobile device. In that embodiment, the audio input may be recorded, and then analyzed to determine the language. In one embodiment, recorded audio input may be converted into an IMS-based message, or the like, and sent to a server device. At the server device, a dictionary, language translator, and/or the like, may be employed to translate the message into the second language. Processing may then flow to block 416.

Alternatively, if the audio input is determined to be in the second language processing branches to block 422. At block 422, the audio input may be recorded and speech recognition, translators, dictionaries, or the like, may be employed to translate the audio input to the first language. As noted above, in one embodiment, the audio input may be converted into an IMS-based message, or the like, and sent to the server device. Processing flows to block 416.

At block 416, the translated audio input may then be provided to the mobile device. In one embodiment, where the translation occurs at the server device, the translated audio input may be converted to an IMS-based message, or the like, and transmitted to the mobile device. In one embodiment, the transmission of the audio input to/from the server device may be encrypted using any of a variety of encryption mechanisms.

It should be noted, that while blocks 414, 422, and 416 describe translations and transmission of an audio input, the invention is not so limited. Thus, for example, in addition to transmitting the translated audio input to the mobile device, at block 416, in one embodiment, a graphical based representation of the audio input may also be transmitted. When the translated audio input is received at the mobile device, it may be made available for playing.

Processing moves next to decision block 418 where a determination is made whether the first or the second language is to be changed. Such determination may be made based on a user providing an input selection, for example, indicating that at least one of the languages is to be changed. This may occur, for example, where there are three or more speakers (each using a different language, or the like). In this manner, the invention may be extended to a plurality of audio input languages, without departing from the scope of the invention. If at least one of the languages is to be changed, processing loops back to block 402; otherwise, processing flows to block 420, where a determination is made whether to exit the audio translation process. If the process is to continue, processing loops back to block 408 for another audio input. Otherwise, processing returns to a calling process to perform other actions.

As illustrated above, one embodiment of process 400 thus enables two (or more) persons to speak into the mobile device using the invention and to understand each other virtually in real-time. For example, a first speaker may provide a first audio input by speaking into the mobile device using a first language. The first audio input may be translated to the second language and returned to the mobile device for listening. The second speaker may then provide a second audio input in the second language and a translated second audio input may then be provided for listening, in virtually real-time.

FIG. 5 generally showing one embodiment of a process for performing a dynamic graphical language translation based, in part, on a current physical location. As described above in conjunction with FIG. 4, process 500 of FIG. 5 may also be implemented entirely within a mobile device, distributed across a mobile device and a server device, or operate within the server device based on inputs from a mobile device.

Process 500 of FIG. 5 may be used, for example, where a user selects to take a photograph, or similar graphical image of a sign, magazine, or other object that includes text to be translated from a second language into a first language. Thus, process 500 begins, after a start block, at block 502 where a first language is selected. As in process 400 above, the first language may be selected using a variety of mechanisms.

Processing then flows to block 504, where a current physical location of the mobile device is determined. In one embodiment, where the mobile device includes a GPS transceiver, or similar locator mechanism, the current physical location may be obtained from the mobile device. However, in another embodiment, the user of the mobile device may also input the current physical location, using any of physical coordinates, city name, country name, or the like.

Process 500 continues next to block 506, where, in one embodiment, substantially similar to block 406 of process 400, the second language may be determined based on the current physical location of the mobile device. However, the second language may also be determined based on an input selection by the user, or the like.

Processing continues to block 508, where a graphical input is received. In one embodiment, the user may employ a mobile device having a camera, scanner, or other graphic capture mechanism, to obtain a graphical image. Moreover, in one embodiment, the graphical input may be sent from the mobile device over a network to a server device. In one embodiment, the graphical input may be transmitted in encrypted form.

Process 500 moves to block 510, where the graphical input may then be converted using, for example, an Optical Character Recognition (OCR) mechanism to extract the text, symbols, or the like, in the second language that is to be translated to the first language. In one embodiment, the OCR conversion and extraction may be performed within the mobile device. However, in another embodiment, the graphical input may be sent over a network to a server where the OCR conversion may occur. In one embodiment, the OCR mechanism may be configured and arranged specific to recognize text and/or symbols associated with the second language.

Processing then flows to decision block 512, where, in one embodiment, the user may view on the mobile device, a result of the OCR conversion to confirm that the conversion was appropriate. If the user determines that the conversion was not correct, for any reason, or for no reason, user may select to resubmit another graphical input. In that situation, processing loops back to block 508; otherwise, processing continues to block 514.

At block 514, the extracted second language text and/or symbols may be then translated to text and/or symbols in the first language. In one embodiment, the resulting translation may be converted into an MMS-based message, IMS-based message, or the like, which is then transmitted, in one embodiment, to the mobile device, at block 516. In one embodiment, the transmission of the translated text and/or symbols may be encrypted.

Processing then continues to decision block 518, where a determination is made whether the graphical input translation is to be exited. This may be based on an action, for example, by the user of the mobile device. If process 500 is to be exited, processing returns to a calling process to perform other actions; otherwise, processing loops back to block 508, where another graphical input may be received. It should be noted, that process 500 may also loop back to block 502, in another embodiment, where the user may then be enabled to modify the selection of the first and/or second languages.

Moreover, in one embodiment, at block 516, additional information associated with the translated text and/or symbols may also be made available to the user, including, for example, a pronunciation audio file, additional images and/or video clips related to a meaning of the translated text and/or symbols, how to use the translated text, origin and/or history of the translated text and/or symbols, or the like.

FIG. 6 illustrates a logical flow diagram generally showing one embodiment of a process for performing dynamic language education based, in part, on a current physical location.

Process 600 of FIG. 6 may be implemented within a mobile device, and/or within a server device, such as mobile devices 102-104 and/or RTS 106 of FIG. 1, respectively.

Process 600 begins, after a start block, at block 602, where, similar to processes 400 and 500, a first language is selected. Then, process 600 flows to block 604, where similar to above, a current physical location of the mobile device is determined, and a second language may, in one embodiment, be determined, based on the current physical location of the mobile device. As above, the second language may also be determined based on a user input selection.

Processing moves next to block 608, where a word, phrase, or other text, may be input. In one embodiment, the word, phrase, or the like, may be converted into an IMS-based message, an MMS-based message, or the like, and transmitted over a network to a server device. In one embodiment, the transmission is encrypted.

At decision block 610, a determination is made whether the received text is in the first language. In one embodiment, the user may so indicate that the text is to be translated to the second language, indicating that the text is in the first language. The user may also indicate that the text is to be translated to the first language from the second language. In any event, if the text is in the first language, processing flows to block 612 where the text is translated to the second language. Otherwise, processing flows to block 620 where the text is translated to the first language. Processing then flows from block 620 or block 612 to block 614.

At block 614, related information may also be determined, that may include, but is not limited to, an audio file indicating how to pronounce the translated text; synonym information; a definition of the text; an image or video file illustrating, for example, a meaning of the text in a graphical way, displaying how the text might be used, an origin, history, or other related information about the translated text.

Processing then flows to block 616, where the translated text and related information may be provided to the mobile device for display, listening, or the like. Processing continues to decision block 618, where a determination is made whether to exit education process 600. If so, processing returns to a calling process to perform other actions; otherwise, processing loops back to block 608 to receive another word/phrase, or other text.

It should be pointed out that while processes 400, 500, and 600 are illustrated as distinct processes, they need not be. Thus, for example, while the user is speaking, the user may also select to obtain a graphical image, seek additional education information, or the like. Thus, in one embodiment, the processes may also be integrated, or implemented in a variety of other configurations, without departing from the scope of the invention.

It will be understood that each block of the flowchart illustration, and combinations of blocks in the flowchart illustration, can be implemented by computer program instructions. These program instructions may be provided to a processor to produce a machine, such that the instructions, which execute on the processor, create means for implementing the actions specified in the flowchart block or blocks. The computer program instructions may be executed by a processor to cause a series of operational steps to be performed by the processor to produce a computer implemented process such that the instructions, which execute on the processor to provide steps for implementing the actions specified in the flowchart block or blocks. The computer program instructions may also cause at least some of the operational steps shown in the blocks of the flowchart to be performed in parallel. Moreover, some of the steps may also be performed across more than one processor, such as might arise in a multi-processor computer system. In addition, one or more blocks or combinations of blocks in the flowchart illustration may also be performed concurrently with other blocks or combinations of blocks, or even in a different sequence than illustrated without departing from the scope or spirit of the invention.

Accordingly, blocks of the flowchart illustration support combinations of means for performing the specified actions, combinations of steps for performing the specified actions and program instruction means for performing the specified actions. It will also be understood that each block of the flowchart illustration, and combinations of blocks in the flowchart illustration, can be implemented by special purpose hardware-based systems which perform the specified actions or steps, or combinations of special purpose hardware and computer instructions.

The above specification, examples, and data provide a complete description of the manufacture and use of the composition of the invention. Since many embodiments of the invention can be made without departing from the spirit and scope of the invention, the invention resides in the claims hereinafter appended.

What is claimed as new and desired to be protected by Letters Patent of the United States is:

1. A mobile device that is operative to enable a language translation, comprising:
a memory component for storing data and processor-executable instructions; and
a processing component for executing processor-executable instructions that enables actions, including:
selecting a first language from a plurality of languages;
providing a current physical location of the mobile device to a server device, wherein the server device is configured to determine a second language from the plurality of languages, in part, based on the current physical location of the mobile device;
providing a first input to the server device, wherein the first input is in the first language or the second language; and
receiving a translation of the first input into the other of the second language or the first language different from that language of the first input based on a determination at the server device of which language the first input is in.

2. The mobile device of claim 1, wherein the first input comprises an audio input.

3. The mobile device of claim 1, wherein the first input comprises a graphical image, and wherein text to be translated is extracted from the graphical image using an Optical Character Recognition mechanism.

4. The mobile device of claim 1, wherein the processing component enables execution of processor-executable instructions that perform actions, further comprising:
receiving information related to the translated first input, wherein the related information further comprises at least one of etymology of the first input, pronounciation guidance, or an image clip illustrating a meaning of the first input.

5. The mobile device of claim 1, wherein the processing component enable execution of processor-executable instructions that perform actions, further comprising:
storing the first input and the translation of the first input in the memory component, such that if a second input is received at the mobile device that matches the first input or the translation of the first input, the first input and the translation of the first input is retrieved and provided to a user of the mobile device.

6. The mobile device of claim 1, wherein the first input is transmitted between the mobile device and the server device using at least one of VOIP, IP Multimedia Subsystem (IMS), or Multimedia Messaging Service (MMS) based messaging.

7. A processor readable medium that includes processor-executable instructions, wherein the execution of the processor-executable instruction enables a language translation to a mobile device over a network by enabling actions, including:
receiving a selection of a first language from a plurality of languages;
determining a current physical location of the mobile device;
determining a second language from the plurality of languages, in part, based on the current physical location of the mobile device;
receiving a first input, wherein the first input is in the first language or the second language;
determining if the first input is in the first language or the second language; and
providing a translation of the first input into the other of the second language or the first language different from that of the determined language of the first input.

8. The processor readable medium of claim 7, wherein determining the second language further comprises, enabling a user of the mobile device to modify the determination of the second language.

9. The processor readable medium of claim 7, wherein the first input further comprises at least one of an audio input or a graphical input.

10. The processor readable medium of claim 7, wherein if the first input further comprises a graphical input, employing an Optical Character Recognition mechanism to extract text to be translated from the graphical input.

11. The processor readable medium of claim 7, wherein if the first input further comprises an audio input, employing speech recognition component.

12. A server device to manage different languages at a mobile device over a network, comprising:
a transceiver to send and receive data over the network; and
a processor that is operative to perform actions, including:
receiving from the mobile device a selection of a first language from a plurality of languages;
receiving a current physical location of the mobile device;
determining a second language from the plurality of languages, in part, based on the current physical location of the mobile device;
receiving a first input, wherein the first input is in the first language or the second language;
determining if the first input is in the first language or the second language; and
providing a translation of the first input into the other of the second language or the first language different from that of the determined language of the first input.

13. The server device of claim 12, wherein the processor is operative to perform actions, further comprising:
receiving a selection to change the second language to another language selected from plurality of languages;
receiving a second input wherein the second input is in the first language or the changed second language;
determining if the second input is in the first language or the changed second language; and
providing a translation of the second input into the other of the changed second language or the first language different from that of the determined language of the second input.

14. The server device of claim 12, wherein at least one of the receiving the first input or providing the translation employs encryption in transmitting over the network.

15. The server device of claim 12, wherein the first input is one of a graphical input or an audio input.

16. The server device of claim 12, wherein the processor is operative to perform actions, further comprising:
determining related information associated with the first input, wherein the related information further comprises at least one of etymology of the first input, pronounciation guidance, historical information associated with the first input, or an image clip illustrating a meaning of the first input.

17. A method of managing a language translation to a mobile device over a network, comprising:
enabling a user to select a first language from a plurality of languages;
determining a current physical location of the mobile device;
determining a second language from the plurality of languages, in part, based on the received current physical location of the mobile device;
receiving a first input in the first language or the second language;
determining if the first input is in the first or the second language; and
providing to the user of the mobile device over the network a translation of the first input into the other of the second language or the first language different from the determined language of the first input.

18. The method of claim 17, wherein determining if the first input is in the first or the second language employs speech recognition.

19. The method of claim 17, wherein providing the translation further comprises providing the translation as one of an audio or a graphical output to the mobile device.

20. A modulated data signal configured to include program instructions for performing the method of claim 17.
